(19) United States
(12) Patent Application Publication
(10) Pub. No.: US 2017/0322385 A1
(43) Pub. Date: Nov. 9, 2017

(54) TELECOMMUNICATIONS ZONE ENCLOSURE

(71) Applicant: The Siemon Company, Watertown, CT (US)

(72) Inventors: Martin R. Harisi, Wolcott, CT (US); David Medeiros, Watertown, CT (US); Brian N. McCaffrey, Woodbury, CT (US)

(21) Appl. No.: 15/584,245

(22) Filed: May 2, 2017

Related U.S. Application Data
(60) Provisional application No. 62/333,448, filed on May 9, 2016.
(60) Provisional application No. 62/330,934, filed on May 3, 2016.

(51) Int. Cl. G02B 6/44; G02B 6/38

(52) U.S. Cl. CPC G02B 6/4452; G02B 6/3897; G02B 6/4453; G02B 6/4471; G02B 6/4441

(57) ABSTRACT

An enclosure includes a pair of opposing sidewalls; a rack having a top bar and two side bars; at least one sidewall including a plurality of openings; a pivot pin coupled to the rack and located in a first opening of the plurality of openings to enable rotation of the rack within the enclosure; and a latch coupled to the rack and located in a second opening of the plurality of openings to fix position of the rack within the enclosure.

### CROSS-REFERENCE TO RELATED APPLICATIONS

This application claims the benefit under 35 U.S.C. §119 of U.S. provisional patent application Ser. No. 62/330,934 filed May 3, 2016, the entire contents of which are incorporated herein by reference and this application claims the benefit under 35 U.S.C. §119 of U.S. provisional patent application Ser. No. 62/333,448 filed May 9, 2016, the entire contents of which are incorporated herein by reference.

### TECHNICAL FIELD

The subject matter disclosed herein relates generally to enclosures for telecommunications components, and in particular to a telecommunications zone enclosure for telecommunications components having a repositionable rack.

### BACKGROUND

Existing telecommunications systems may employ a zone cabling design. A zone cabling design (or topology) begins with horizontal cables (fiber, copper, coax, etc.) that run from patch panels in the telecommunications room (TR) to connections within a zone enclosure (ZE, sometimes referred to as a zone box), which can be mounted under a raised floor, in the ceiling, or on the wall. Cables are then run from outlets or connecting blocks in the zone enclosure to telecommunications outlets in the work area (WA), equipment outlets serving building automation system (BAS) devices, or directly to BAS devices. Patch cords are used to connect voice and data equipment to telecommunications outlets and to connect BAS equipment to equipment outlets.

Existing zone enclosures may include a panel where horizontal cabling is terminated to an outlet, and a patch cord is mated to the outlet. Often, telecommunications components mounted inside the enclosure are mounted in a fixed position, making it difficult for installers to access the telecommunications components. Zone enclosures having more flexible access to telecommunications components would be well-received in the art.

### BRIEF DESCRIPTION OF THE DRAWINGS

Referring now to the drawings wherein like elements are numbered alike in the FIGURES:

FIG. 1 is a perspective view of a zone enclosure in an embodiment;

FIG. 2 is a perspective view of a zone enclosure in an embodiment;

FIG. 3 is a side view of a zone enclosure in an embodiment;

FIG. 4 is a perspective view of a zone enclosure fitted with a patch panel in an embodiment;

FIG. 5 is a perspective view of a zone enclosure in an embodiment;

FIG. 6 is a side view of a zone enclosure in an embodiment;

FIG. 7 is a perspective view of a zone enclosure fitted with a telecommunications component in an embodiment;

FIG. 8 is a perspective view of a zone enclosure in an embodiment;

FIG. 9 is a side view of a zone enclosure in an embodiment;

FIG. 10 is a perspective view of a zone enclosure fitted with a mounting board in an embodiment; and

FIG. 11 is a perspective view of a zone enclosure with a bottom cover opened.

### DETAILED DESCRIPTION

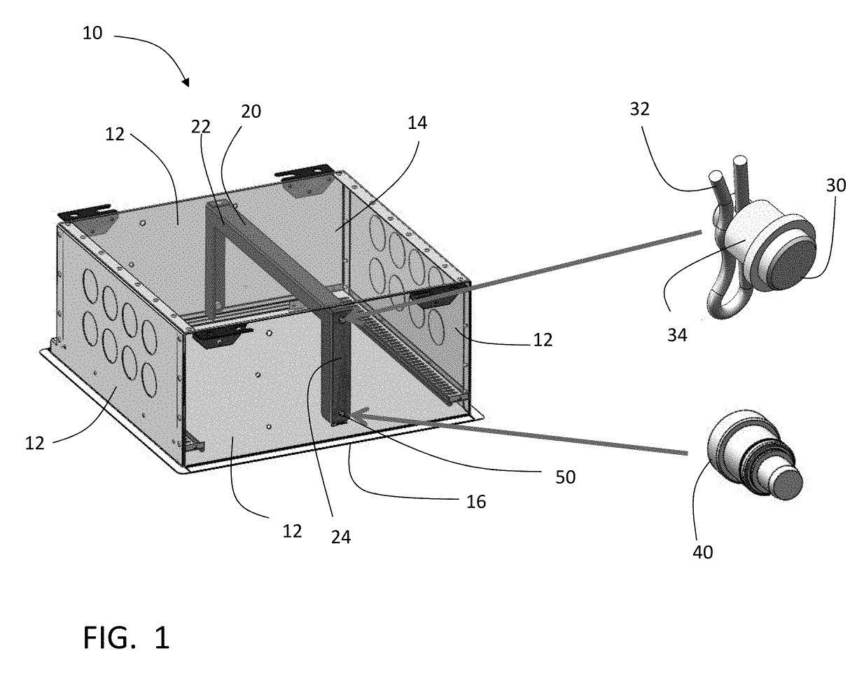

FIG. 1 is a perspective view of a zone enclosure 10 in an embodiment.

Enclosure 10 includes four sidewalls 12, a top wall 14 and a bottom door 16. Enclosure 10 is intended for mounting in a ceiling area, but embodiments are not limited to ceiling mounted enclosures. A rack 20 is positioned inside the enclosure 10 and is fixable in a plurality of positions as disclosed in further detail herein. Rack 20 includes a top bar 22 and two side bars 24 to define a generally rectangular rack 20. Rack 20 lacks a bottom bar or support, so that sliding components into the rack 20 is facilitated. The top bar 22 may be pivotally secured to opposite walls 12 to allow the entire rack 20 to rotate within the enclosure 10. One or more pivot pins 30 pass through openings in opposite sidewalls 12 and openings in rack 20. A cotter pin 32, or similar retention member, is used to hold the pivot pin 30 in place. A bushing 34 may encircle a portion of the pivot pin 30.

The rack 20 may also include one or more latches 40 to fix the position of the rack 20 inside enclosure 10. Latches 40 may be spring loaded, cylindrical posts that can be depressed or defeated using a finger or tool. Latches 40 may pass through an opening in rack 20 and an opening in one of the sidewalls 12 to fix the position of the rack 20. In one embodiment, two latches 40 are used, one located in each side bar 24 of rack 20. The sidewalls 12 include a plurality of openings to allow the rack 20 to be positioned in a vertical orientation, at least one angled orientation, and a horizontal orientation, as described in further detail herein. As shown in FIG. 1, the latch 40 is positioned in an opening 50 in sidewall 12, to fix the rack 20 in a vertical orientation. A second, similar latch 40 may be mounted in a similar opening in the opposite sidewall 12.

When installing or accessing components inside the enclosure 10, an installer may defeat latch 40 to enable rotation of the rack 20. This allows the installer to have access to the front of rack 20 and then rotate the rack to a second position for access to the rear of the rack 20. The latch 40 may be used to hold the rack 20 in the second position

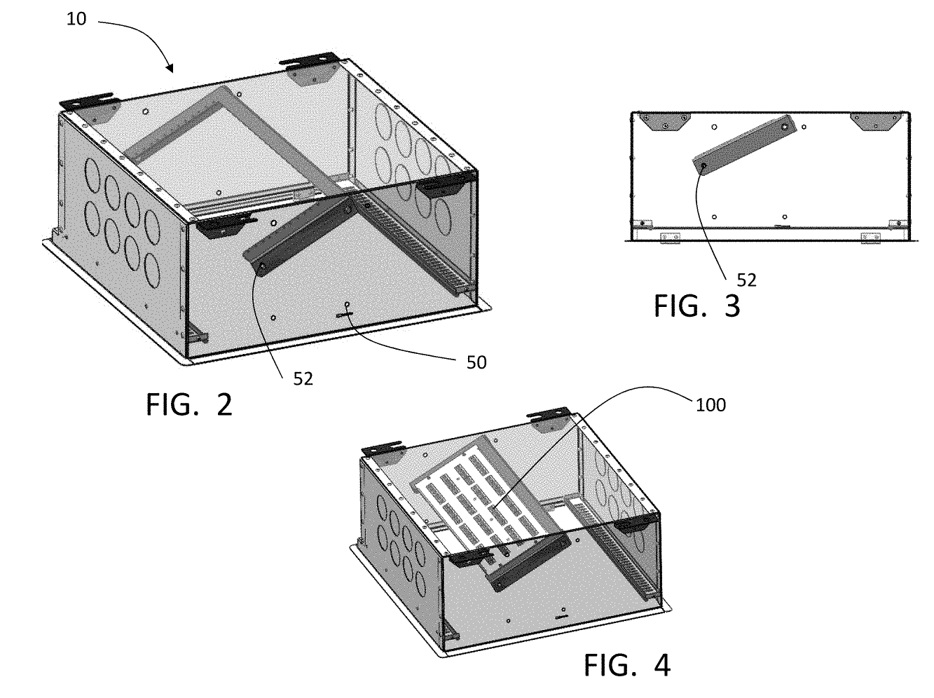

FIG. 2 is a perspective view of enclosure 10 with rack 20 secured in a first angular orientation, between the vertical orientation and horizontal orientation. Latch 40 is positioned in opening 52, which fixes the rack 20 in the first angular orientation. FIG. 3 is a side view showing rack 20 in the first angular orientation. FIG. 4 is a perspective view of enclosure 10 fitted with a patch panel 100 in an embodiment. By fixing the rack 20 at the first angular position as shown in FIG. 4, an installer can access the rear of the patch panel 100 more easily. The rack 20 can be returned to vertical by defeating latch 40 in opening 52, rotating rack 20 to the vertical orientation and securing latch 40 in opening 50. In some embodiments, each side arm 24 includes a latch 40 to engage openings in opposite sidewalls 12.

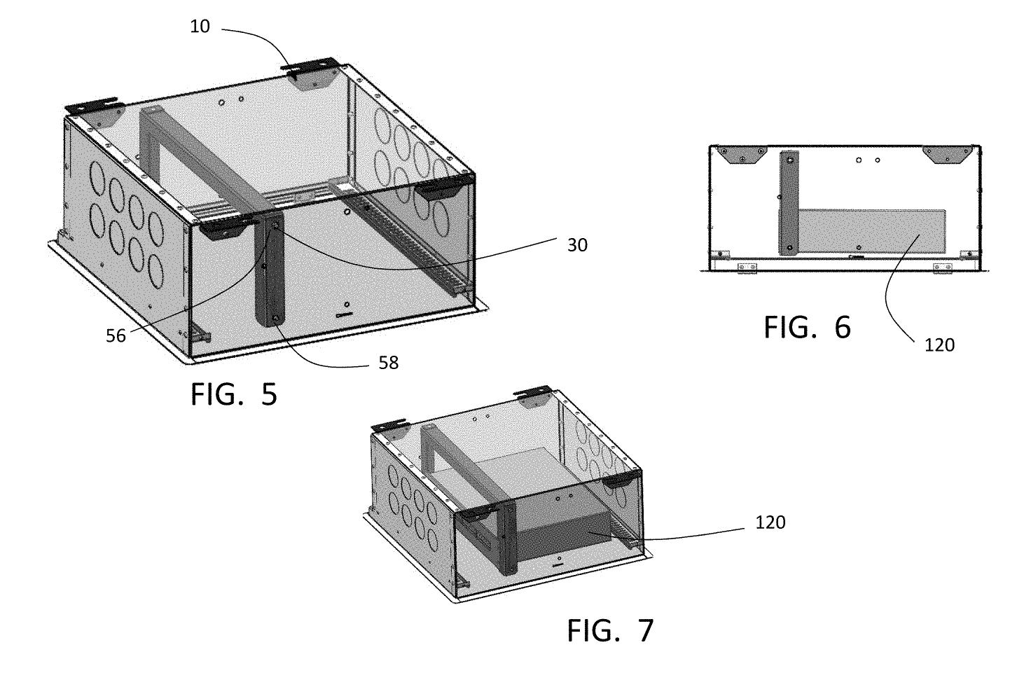

FIG. 5 is a perspective view of an enclosure 10 in an embodiment. In FIG. 5, the rack 20 is displaced towards one sidewall, rather than in the center of the enclosure 10. The pivot pins 30 are positioned in openings 56 in opposite sidewalls 12. Latches 40 may be positioned in openings 58 in the opposite sidewalls 12 to secure rack 20 in a vertical position. This offsets the rack 20 relative to the centerline of the enclosure 10 and allows for installation of larger telecommunications components. FIG. 6 is a side view of zone enclosure 10 with a larger telecommunications component 120 (e.g., a fiber optic panel). FIG. 7 is a perspective view of the enclosure 10 fitted with the larger telecommunications component 120.

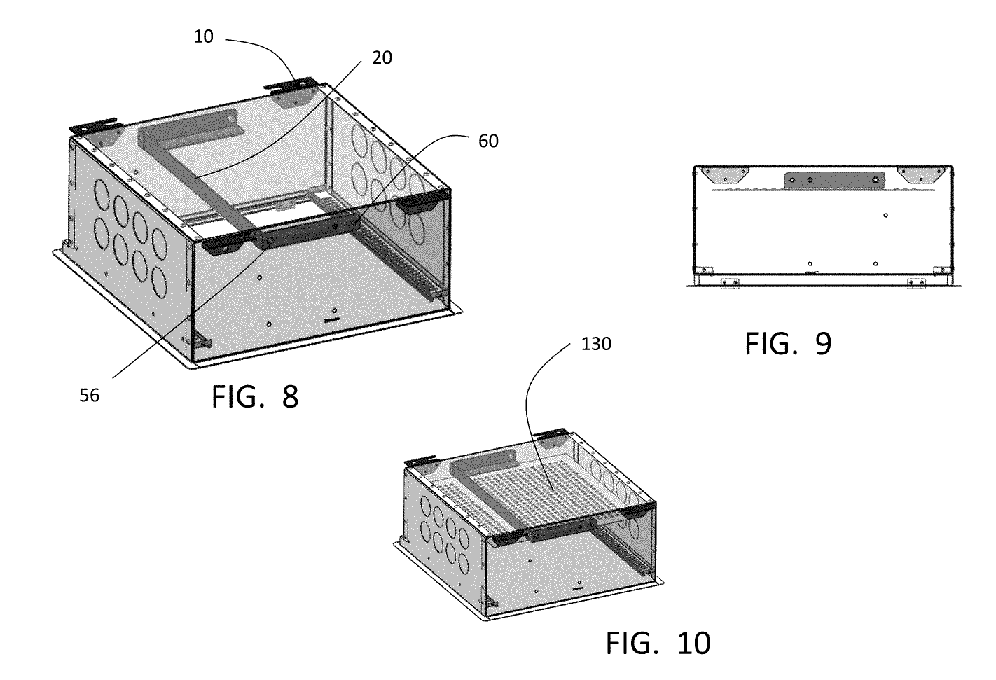

FIG. 8 is a perspective view of zone enclosure 10 with rack 20 secured in a horizontal orientation. The pivot pins 30 may be located in openings 58 in opposite sidewalls 12. One or two latches 40 are positioned in openings 62 to fix the rack 20 in a horizontal orientation. FIG. 9 is a side view showing rack 20 in the horizontal orientation. FIG. 10 is a perspective view of zone enclosure 10 fitted with a mounting board 130 in an embodiment.

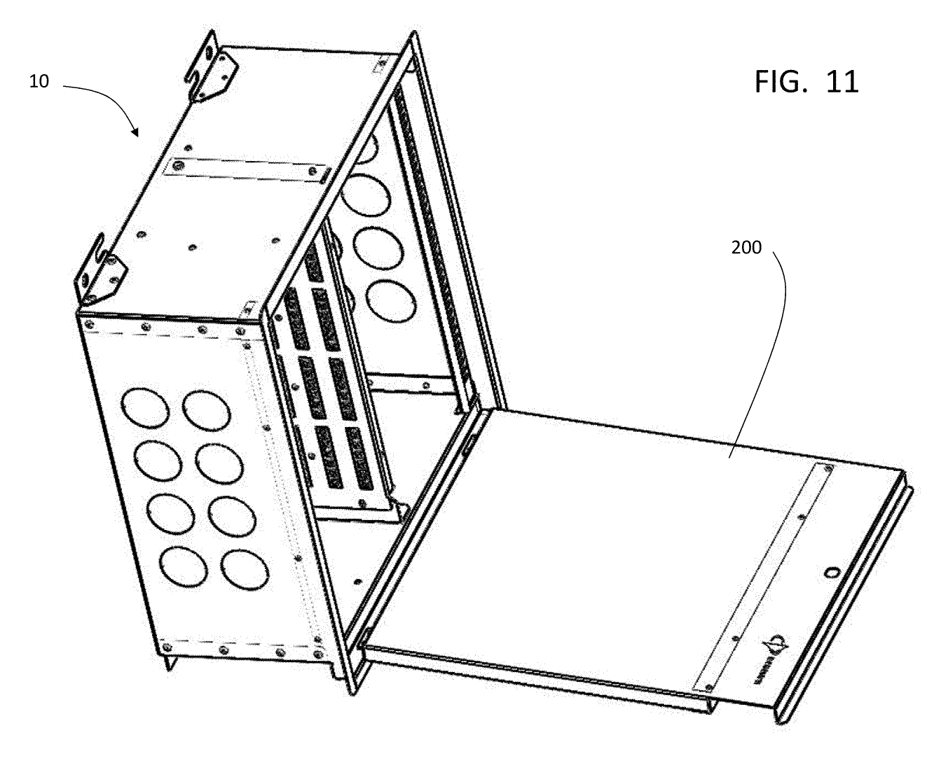

FIG. 11 is a perspective view of a zone enclosure 10 with a bottom cover 200 opened. The bottom cover 200 is hingedly secured to the zone enclosure 10 at one edge and can rotate between open and closed positions. The bottom cover 200 is positioned opposite the top wall 14 and hinged to one of the sidewalls 12. This allows users to access the interior of the zone enclosure 10. A latch (not shown) may be used to keep the bottom cover 200 in a closed position.

The use of moveable pivot pins 30 and one or more movable latches 40 allows the rack 20 to be positioned in a number of positions and orientations inside enclosure 10. A first group of openings in opposing sidewalls of the enclosure 10 allow the rack 20 to be repositioned along a translational axis (e.g., along the lateral or longitudinal axis of the enclosure). Another group of openings in the opposing sidewalls provide for fixing the orientation of rack 20 including at least two of horizontal orientation, vertical orientation and an angular orientation between horizontal and vertical. Latch(es) 40 may be easily defeated to allow the rack 20 to rotate to a position that facilitates installation/maintenance and then rotated back to an original position.

The terminology used herein is for the purpose of describing particular embodiments only and is not intended to be limiting of the invention. While the description of the present invention has been presented for purposes of illustration and description, it is not intended to be exhaustive or limited to the invention in the form disclosed. Many modifications, variations, alterations, substitutions, or equivalent arrangement not hereto described will be apparent to those of ordinary skill in the art without departing from the scope and spirit of the invention. Additionally, while the various embodiments of the invention have been described, it is to be understood that aspects of the invention may include only some of the described embodiments. Accordingly, the invention is not to be seen as being limited by the foregoing description.

What is claimed is:

1. An enclosure comprising:
a pair of opposing sidewalls;
a rack having a top bar and two side bars;
at least one sidewall including a plurality of openings;
a pivot pin coupled to the rack and located in a first opening of the plurality of openings to enable rotation of the rack within the enclosure; and
a latch coupled to the rack and located in a second opening of the plurality of openings to fix position of the rack within the enclosure.

2. The enclosure of claim 1, wherein the second opening is located to fix the rack in a vertical orientation.

3. The enclosure of claim 2, further comprising:
a third opening of the plurality of openings positioned to receive the latch and fix the rack in a second orientation other than the vertical orientation.

4. The enclosure of claim 3, wherein the second orientation is a horizontal orientation.

5. The enclosure of claim 3, wherein the second orientation is an angular orientation between the horizontal orientation and the vertical orientation.

6. The enclosure of claim 1, wherein the plurality of openings includes a first group of openings to define a location of the rack along a translational axis and a second group of openings to define an orientation of the rack.

7. The enclosure of claim 1, wherein the plurality of openings are formed in two opposing sidewalls.

8. The enclosure of claim 1, further comprising a bottom cover hingedly secured to the enclosure.
